(19) United States
(12) Patent Application Publication
(10) Pub. No.: US 2025/0135797 A1
(43) Pub. Date: May 1, 2025

(54) THERMAL PRINTER CONTROL DEVICE, THERMAL PRINTER, THERMAL PRINTER CONTROL METHOD, AND PROGRAM

(71) Applicant: Seiko Instruments Inc., Chiba-shi (JP)

(72) Inventor: Koki YOSHIDA, Chiba-shi (JP)

(21) Appl. No.: 18/927,453

(22) Filed: Oct. 25, 2024

(30) Foreign Application Priority Data
Oct. 31, 2023 (JP) 2023-187066

(51) Int. Cl. B41J 29/393; B41J 2/32; B41J 3/407; B41J 11/00; B41J 11/46

(52) U.S. Cl. CPC B41J 29/393; B41J 2/32; B41J 3/4075; B41J 11/0095; B41J 11/46; B41J 2029/3935

(57) ABSTRACT

A thermal printer control device for controlling a thermal printer which includes a thermal head and which is configured to perform printing on a sheet having a mark arranged thereon. The thermal printer control device includes: a sensor value acquisition module configured to acquire a sensor value detected by a sensor configured to detect an intensity of reflected light obtained when light is irradiated on the sheet; a threshold value calculation module configured to calculate a threshold value for detecting a presence or absence of the mark based on the sensor value acquired by the sensor value acquisition module; and a determination module configured to determine the presence or absence of the mark based on a result of comparing the sensor value acquired by the sensor value acquisition module and the threshold value calculated by the threshold value calculation module. The threshold value calculation module is configured to calculate the threshold value based on a first sensor value which is the sensor value obtained when the mark is detected and a second sensor value which is the sensor value obtained when the mark is not detected.

### RELATED APPLICATIONS

This application claims priority to Japanese Patent application No. JP 2023-187066 filed on Oct. 31, 2023, the entire content of which is incorporated herein by reference.

### BACKGROUND OF THE INVENTION

### 1. Field of the Invention

The present invention relates to a thermal printer control device, a thermal printer, a thermal printer control method, and a program.

### 2. Description of the Related Art

Hitherto, there has been a technology which uses a printing system such as a thermal printer to print on labels that are consecutively arranged on a roll sheet having a liner. When such a technology is used, the printing system detects a gap between the labels, and identifies a printing start position in the conveyance direction of the labels. For example, there is a publication which discloses a technology for suitably detecting the gap between labels (see Japanese Patent Application Laid-open No. 2022-108544). In the publication, it is described that a photosensor is used to detect a degree of transmission in a sheet conveyance portion as a sensor value, and a gap portion is determined based on a moving average of the detected sensor values.

When a printing system such as a thermal printer handles label sheets with a liner, which have a liner, as well as label sheets without a liner (also called “linerless labels”), which do not have a liner, in some cases, a path along which the sheet passes is designed to be larger in the height direction. When the path along which the sheet passes is larger, the area in which the label can move in the height direction also becomes larger, and hence the distance from a fixed position of the sensor to the label varies during label conveyance. That is, there is a problem in that variation in the sensor values during label conveyance increases, and false detections occur based on the variation.

The present invention has been made in view of the above-mentioned circumstances, and an object of the present invention is to provide a thermal printer control device, a thermal printer, a thermal printer control method, and a program with which the position of a label can be suitably detected.

### SUMMARY OF THE INVENTION

According to one embodiment of the present invention, there is provided a thermal printer control device for controlling a thermal printer which includes a thermal head and which is configured to perform printing on a sheet having a mark arranged thereon. The thermal printer control device includes: a sensor value acquisition module configured to acquire a sensor value detected by a sensor configured to detect an intensity of reflected light obtained when light is irradiated on the sheet; a threshold value calculation module configured to calculate a threshold value for detecting a presence or absence of the mark based on the sensor value acquired by the sensor value acquisition module; and a determination module configured to determine the presence or absence of the mark based on a result of comparing the sensor value acquired by the sensor value acquisition module and the threshold value calculated by the threshold value calculation module. The threshold value calculation module is configured to calculate the threshold value based on a first sensor value which is the sensor value obtained when the mark is detected and a second sensor value which is the sensor value obtained when the mark is not detected.

In the above-mentioned thermal printer control device according to the one embodiment of the present invention, wherein the second sensor value is a moving average calculated from N sensor values acquired from the same sensor, where N is a natural number of 1 or more.

In the above-mentioned thermal printer control device according to the one embodiment of the present invention, wherein

In the above-mentioned thermal printer control device according to the one embodiment of the present invention, further including a sheet information acquisition module configured to acquire information on the sheet including information on a length of the mark in a conveyance direction, wherein a magnitude of N is determined based on the information on the length of the mark in the conveyance direction acquired by the sheet information acquisition module.

In the above-mentioned thermal printer control device according to the one embodiment of the present invention, wherein the first sensor value is a maximum value of the sensor values.

In the above-mentioned thermal printer control device according to the one embodiment of the present invention, wherein the threshold value calculation module is configured to calculate the threshold value by setting the first sensor value to a value larger than the maximum value of the sensor values when a magnitude of N is equal to or less than a predetermined magnitude.

In the above-mentioned thermal printer control device according to the one embodiment of the present invention, wherein the threshold value calculation module is configured to update the threshold value each time a downstream end of the mark in a conveyance direction is detected based on a result determined by the determination module.

In the above-mentioned thermal printer control device according to the one embodiment of the present invention, wherein the determination module is configured to determine the presence or absence of the mark each time a pulse is applied to a stepping motor configured to convey the sheet, and to determine that a portion of the sheet is not the mark when the determination module consecutively determines a predetermined number of times or more that the mark is not present based on a length of the mark in a conveyance direction.

According to one embodiment of the present invention, there is provided a thermal printer including: a conveyance motor configured to convey a sheet; a thermal head configured to perform printing by subjecting the sheet to heat; a sensor configured to detect an intensity of reflected light obtained when light is irradiated on the sheet; and the thermal printer control device, which is configured to detect the presence or absence of the mark based on the sensor value detected by the sensor, and to control printing based on a position of the mark.

According to one embodiment of the present invention, there is provided a thermal printer control method of controlling a thermal printer which includes a thermal head and which is configured to perform printing on a sheet having a mark arranged thereon. The thermal printer control method includes: acquiring a sensor value detected by a sensor configured to detect an intensity of reflected light obtained when light is irradiated on the sheet; calculating a threshold value for detecting a presence or absence of the mark based on the sensor value acquired in the acquiring of the sensor value; and determining the presence or absence of the mark based on a result of comparing the sensor value acquired in the acquiring of the sensor value and the threshold value calculated in the calculating of the threshold value. The calculating of the threshold value includes calculating the threshold value based on a first sensor value which is the sensor value obtained when the mark is detected and a second sensor value which is the sensor value obtained when the mark is not detected.

According to one embodiment of the present invention, there is provided a program for causing a computer to control a thermal printer which includes a thermal head and which is configured to perform printing on a sheet having a mark arranged thereon. The program causes the computer to execute: acquiring a sensor value detected by a sensor configured to detect an intensity of reflected light obtained when light is irradiated on the sheet; calculating a threshold value for detecting a presence or absence of the mark based on the sensor value acquired in the acquiring of the sensor value; and determining the presence or absence of the mark based on a result of comparing the sensor value acquired in the acquiring of the sensor value and the threshold value calculated in the calculating of the threshold value. The calculating of the threshold value includes calculating the threshold value based on a first sensor value which is the sensor value obtained when the mark is detected and a second sensor value which is the sensor value obtained when the mark is not detected.

### BRIEF DESCRIPTION OF THE DRAWINGS

FIG. 1 is a diagram for illustrating an example of a schematic configuration of a printing system, and an example of a schematic appearance of a thermal printer, according to at least one embodiment of the present invention.

FIG. 2 is a diagram for illustrating an example of a schematic configuration of a label sheet with a liner which is being subjected to position detection by the printing system in the at least one embodiment.

FIG. 3 is a diagram for illustrating an example of a schematic configuration of a label sheet without a liner which is being subjected to position detection by the printing system in the at least one embodiment.

FIG. 4 is a cross-sectional view as viewed from a side of the thermal printer according to the at least one embodiment.

FIG. 5 is a graph for showing a relationship between a distance from a surface of a second sensor to a sheet and a theoretical value of a voltage output from the second sensor in the at least one embodiment.

FIG. 6 is a graph for showing changes in the theoretical value of the voltage output from the second sensor during sheet conveyance in the at least one embodiment.

FIG. 7 is a graph for showing an output waveform of a sensor during sheet conveyance, a moving average waveform for N dots, and a maximum value waveform of a previous gap portion in the at least one embodiment.

FIG. 8 is a graph for showing an output waveform of a sensor during sheet conveyance, a moving average waveform for N dots, a maximum value waveform of a previous gap portion, and a threshold value waveform in the at least one embodiment.

FIG. 9 is a function configuration diagram for illustrating an example of a function configuration of the thermal printer according to the at least one embodiment.

FIG. 10 is a function configuration diagram for illustrating an example of a detailed function configuration of a processing unit included in the thermal printer according to the at least one embodiment.

FIG. 11 is a flowchart for illustrating a series of operations performed by the thermal printer according to the at least one embodiment for determining whether a portion of the sheet is a mark portion or a paper portion.

### DETAILED DESCRIPTION OF THE PREFERRED EMBODIMENTS

Now, at least one embodiment of the present invention is described with reference to the drawings.

### At Least One Embodiment

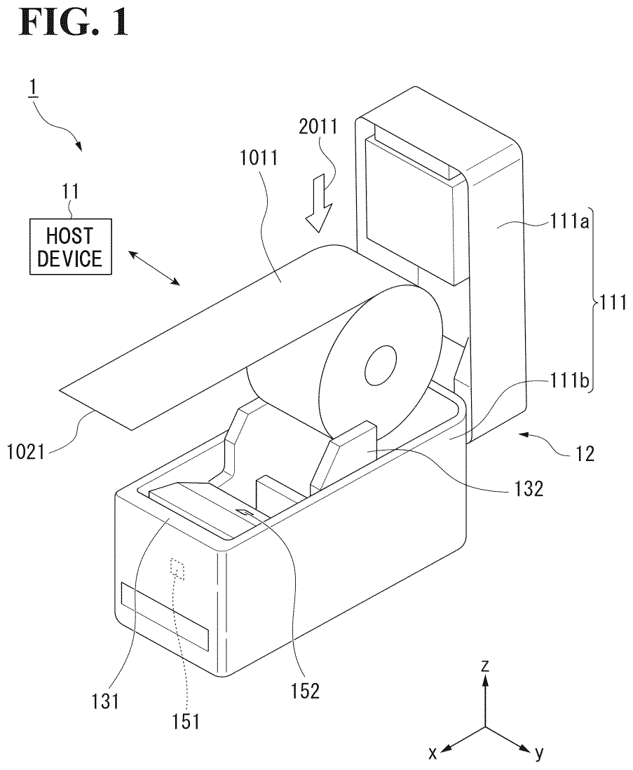

FIG. 1 is a diagram for illustrating an example of a schematic configuration of a printing system 1, and an example of a schematic appearance of a thermal printer 12, according to the at least one embodiment. The example of the schematic configuration of the printing system 1 and the example of the schematic appearance of the thermal printer 12 are described with reference to FIG. 1. The printing system 1 includes a host device 11 and the thermal printer 12. The host device 11 and the thermal printer 12 connected to each other by wire or wirelessly so that the host device 11 and the thermal printer 12 can communicate to and from each other. The thermal printer 12 is a printer which includes a thermal head, and prints on thermal paper, for example, by using a thermal transfer method or a direct thermal method. In the following description, a case in which the thermal printer 12 performs printing by using the direct thermal method is given as an example.

In the description given with reference to FIG. 1, a case in which a positional relationship or the like of the components included in the thermal printer 12 may be described based on a three-dimensional orthogonal coordinate system of an x-axis, a y-axis, and a z-axis. The “x” direction is the direction in which the sheet is conveyed. The “y” direction is a direction orthogonal to the conveyance direction, and is a printing direction in which the thermal printer prints one dot line. The “y” direction can also be referred to as “row direction,” and the “x” direction can also be referred to as “column direction.” Further, the “z” direction is a direction orthogonal to the conveyance direction, and is a height direction.

When the communication method between the host device 11 and the thermal printer 12 is by wire, a communication standard such as universal serial bus (USB) may be used, for example. Further, when the communication method between the host device 11 and the thermal printer 12 is wireless, a communication standard such as Wi-Fi or Bluetooth (trademark) may be used, for example.

The host device 11 is, for example, an information communication device such as a notebook computer, a laptop computer, a smartphone, or a tablet terminal. The host device 11 includes at least a processor such as a central processing unit (CPU), and a memory such as a read-only memory (ROM) and a random-access memory (RAM). The host device 11 executes various types of processing by using the processor to execute predetermined programs. The programs may be stored in the memory.

The host device 11 controls printing processing performed by the thermal printer 12 by, for example, transmitting a print command to the thermal printer 12. The print command transmitted from the host device 11 to the thermal printer 12 may include information required for printing such as print data.

The thermal printer 12 includes a housing 111. The housing 111 includes a housing upper portion 111a and a housing lower portion 111b. The housing upper portion 111a may be referred to as “top cover,” for example. Further, the thermal printer 12 includes a sheet delivery slot 131, a pincher 132, a first sensor 151, and a second sensor 152. In the example of FIG. 1, a configuration in which the first sensor 151 and the second sensor 152 are arranged in the housing lower portion 111b is illustrated, but the at least one embodiment is not limited to that configuration. For example, a configuration in which the first sensor 151 is arranged in the housing upper portion 111a may be used. Further, depending on the printing medium, the thermal printer 12 may include a third sensor (not shown), for example.

A sheet 1011 is set in the thermal printer 12. In the example of FIG. 1, the sheet 1011 is a roll sheet. The roll sheet may be a label sheet with a liner in which labels are arranged on a liner, or a label sheet without a liner (hereinafter sometimes referred to as “linerless label sheet”), which does not have a liner. In FIG. 1, a leading edge 1021 of the sheet 1011 and a direction 2011 in which the sheet 1011 is dropped into the housing lower portion 111b of the thermal printer 12 are illustrated. A predetermined mark for detecting the position of the roll sheet may be arranged on the sheet 1011, but a mark is not shown in FIG. 1.

In the at least one embodiment, the second sensor 152 is illustrated as being positioned on the near side (forward direction) in the “y” direction, but the position of the second sensor 152 in the “y” direction may be variable. For example, the position of the second sensor 152 in the “y” direction may be adjusted by the pincher 132 in accordance with a sheet width. When the thermal printer 12 includes a third sensor (not shown), the third sensor may be fixedly arranged at a position which is the same as the second sensor 152 in the “x” direction and the “z” direction but different from the second sensor 152 in the “y” direction.

An outline of operation of the thermal printer 12 according to the at least one embodiment is now described. The thermal printer 12 according to the at least one embodiment can determine the type of the sheet, for example, plain paper (for example, receipt paper), a label sheet without a liner, and a label sheet with a liner. The determination is performed based on the intensity of light received by the second sensor 152, which is a reflective photointerrupter.

To set a sheet in the thermal printer 12, the user drops the roll sheet in the predetermined direction 2011, operates the pincher 132 to match the sheet width, and closes the housing upper portion 111a. In the at least one embodiment, the determination time can be shortened by setting the leading edge 1021 of the sheet to be within 50 mm from the sheet delivery slot 131.

After the housing upper portion 111a is closed, the thermal printer 12 uses the first sensor 151 to determine the presence or absence of a sheet. When it is determined by the first sensor 151 that there is a sheet, the thermal printer 12 conveys the sheet in a reverse direction until the sheet is no longer present so that the sheet can be used from the first label or the leading edge of the sheet (the operation of conveying the sheet in the reverse direction is hereinafter sometimes referred to as “backfeed”). During this operation, detection by the second sensor 152 is not performed. The reason for this is so that the sheet can be used from the leading edge. When the set sheet is a linerless label, it is not required to perform backfeed. This is because for linerless labels, backfeed may cause adhesive portions to stick together, resulting in paper jams.

In the example of FIG. 1, it is preferred that the second sensor 152 be arranged at a position corresponding to a mark on the roll sheet (not shown in FIG. 1). Depending on the roll sheet, the roll sheet may not have a mark.

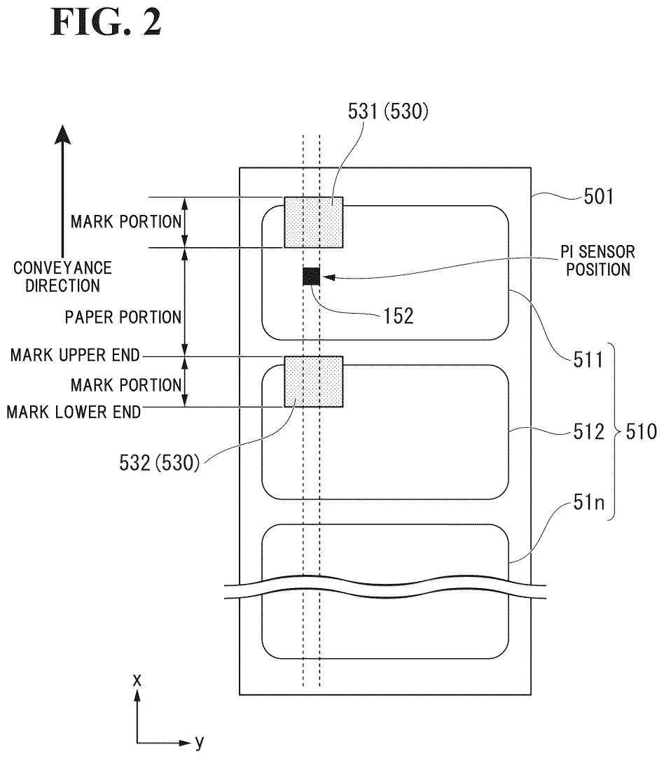

FIG. 2 is a diagram for illustrating an example of a schematic configuration of a label sheet with a liner which is being subjected to position detection by the printing system in the at least one embodiment. An example of a label sheet with a liner 501 which is being subjected to position detection by the printing system 1 is described with reference to FIG. 2. On the label sheet with a liner 501, a plurality of labels 510 are consecutively arranged at predetermined intervals. An adhesive substance is applied to the labels 510 on the label sheet with a liner 501 side. The labels 510 and the label sheet with a liner 501 are adhered to each other, but the labels 510 and the label sheet with a liner 501 can be easily separated. In the example of FIG. 2, labels 511, 512, . . . , label 51n (“n” is a natural number of 1 or more) are arranged on the label sheet with a liner 501.

A mark 530 indicating the position of each label 510 is arranged on a surface of the label sheet with a liner 501 different from the label 510 side. In the example of FIG. 2, a mark 531 is arranged as the mark 530 corresponding to the label 511, and a mark 532 is arranged as the mark 530 corresponding to the label 512. The mark 530 may be printed on a surface of the label sheet with a liner 501 different from the label 510 side by, for example, an inkjet printer. In the following description, the range in which the mark 530 is present in the “x” direction (conveyance direction of the sheet) may be referred to as “mark portion.” The end of the mark portion closer to the delivery slot of the thermal printer 12 may be referred to as “upper end of the mark,” and the end farther from the delivery slot of the thermal printer 12 may be referred to as “lower end of the mark.” Further, in the “x” direction, the range from the lower end of one mark to the upper end of another adjacent mark portion may be referred to as “paper portion.”

The second sensor 152 is arranged in the “y” direction at a position at which the mark 530 can be detected. The position at which the mark 530 can be detected is, for example, a position at which the mark 530 and the second sensor 152 overlap in the “y” direction. More specifically, it is preferred that the second sensor 152 be arranged at the center of the mark 530 in the “y” direction. It is noted that a photointerrupter may be used as a specific configuration of the second sensor 152, and thus in the following description, the second sensor 152 may be referred to as a “PI (photointerrupter) sensor.”

The configuration of the label sheet with a liner 501 illustrated in FIG. 2 is a schematic example, and the shape of the liner, the shape of the labels, the spacing of the labels, the spacing of the marks, the shape of the marks, and the position of the marks, for example, are not limited to the example illustrated in FIG. 2.

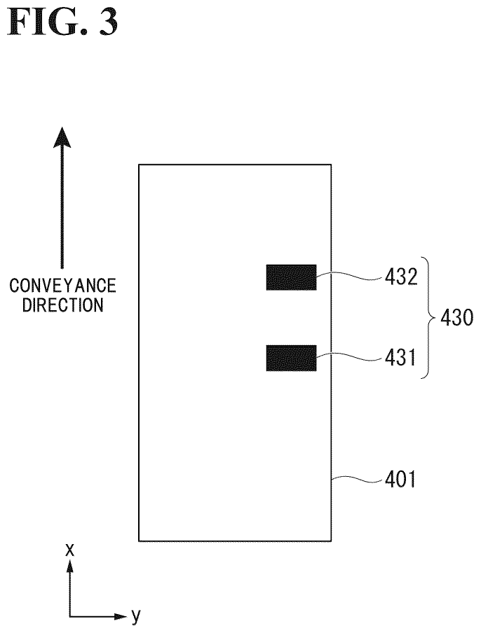

FIG. 3 is a diagram for illustrating an example of a schematic configuration of a label sheet without a liner which is being subjected to position detection by the printing system in the at least one embodiment. An example of a label sheet without a liner 401 which is being subjected to position detection by the printing system 1 is described with reference to FIG. 3. The label sheet without a liner 401 differs from the label sheet with a liner 501 in that the label sheet without a liner 401 does not include a liner. The label sheet without a liner 401 is rolled so that the adhesive surface of the label directly touches the printing surface.

A mark 430 is arranged at predetermined intervals on the adhesive surface of the label sheet without a liner 401. The mark 430 may be printed on the adhesive surface of the label sheet without a liner 401 by, for example, an inkjet printer. Specifically, in the example of FIG. 3, a mark 431 and a mark 432 are arranged. More specifically, the marks 430 are arranged to the right of the center of the label sheet without a liner 401 at predetermined intervals in the vertical direction. For example, the plurality of marks may be arranged at fixed intervals along the whole of one roll.

The configuration of the label sheet without a liner 401 illustrated in FIG. 3 is a schematic example, and the shape of the labels, the interval between the marks, the shape of the marks, and the position of the marks, for example, are not limited to the example illustrated in FIG. 3.

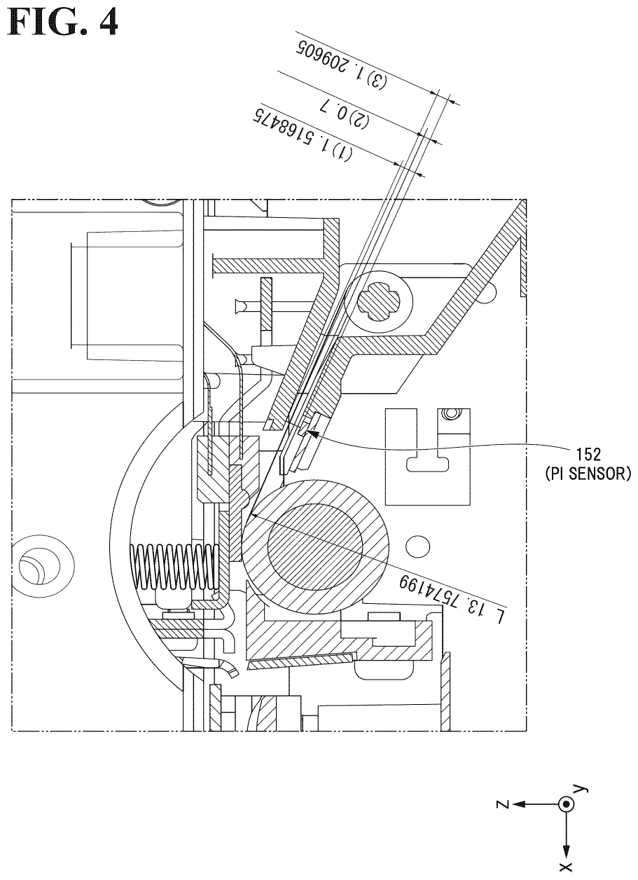

FIG. 4 is a cross-sectional view as viewed from a side of the thermal printer according to the at least one embodiment. In FIG. 4, an example of a cross-sectional view obtained when the thermal printer 12 is viewed from the side from the positive direction to the negative direction of the y-axis is illustrated. The configuration example of the thermal printer 12 illustrated in FIG. 4 is a specific example of the thermal printer 12 illustrated in FIG. 1.

The second sensor 152 is arranged on the lower side of the conveyance path, irradiates light toward the upper side of the conveyance path, and detects the intensity of reflected light. The intensity of the reflected light changes due to the sheet passing above the second sensor 152, and hence the intensity of the light detected by the second sensor 152 changes. The distance from the surface of the second sensor 152 to the upper side of the conveyance path (indicated by (1) in FIG. 4) is approximately 1.5 [mm (millimeters)]. The distance from the surface of the second sensor 152 to the lower side of the conveyance path (indicated by (2) in FIG. 4) is approximately 0.7 [mm]. The distance from the surface of the second sensor 152 to the line connecting the surfaces of the rollers located before and after the second sensor 152 (that is, the ideal position for conveying the sheet) (indicated by (3) in FIG. 4) is approximately 1.2 [mm]. When both label sheet with a liner and label sheet without a liner are conveyed, the path along which the sheet passes may thus become larger than in other cases.

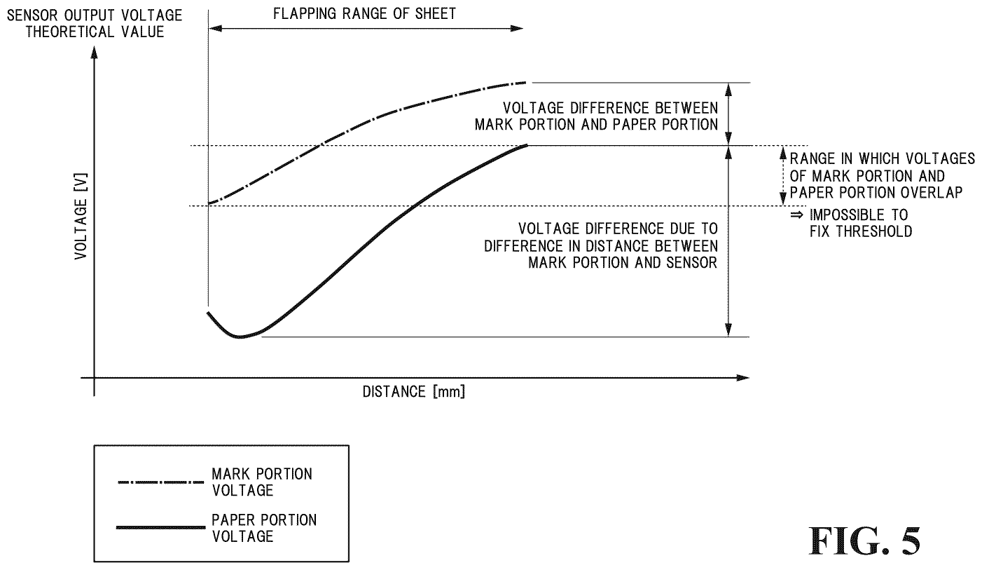

Next, the change in the intensity of light detected by the second sensor 152 is described with reference to FIG. 5 to FIG. 8.

FIG. 5 is a graph for showing a relationship between a distance from the surface of the second sensor 152 to the sheet and a theoretical value of the voltage output from the second sensor 152. The horizontal axis indicates the distance [mm] from the surface of the second sensor 152 to the sheet, and the vertical axis indicates the theoretical value [V (volts)] of the voltage output from the second sensor 152. The solid line indicates results obtained when the light irradiated by the second sensor 152 is reflected by the paper portion (see FIG. 2). The broken line indicates results obtained when the light irradiated by the second sensor 152 is reflected by the mark portion (see FIG. 2). Further, in FIG. 5, the range in which the sheet flaps along the conveyance path in both left and right directions is shown.

As shown in FIG. 5, the voltage value output from the second sensor 152 increases as the distance from the surface of the second sensor 152 to the sheet increases. When the distance from the surface of the second sensor 152 to the sheet is known, it is possible to determine whether the portion of the sheet is a mark portion or a paper portion based on a predetermined threshold value. However, the distance from the surface of the second sensor 152 to the sheet is not known, and thus how to set the threshold value becomes an issue. For example, there is a range in which the voltages of the mark portion and the paper portion overlap, and hence when the voltage value is within that range, it is impossible to determine whether the portion of the sheet is a mark portion or a paper portion. That is, there is a problem in that it is impossible to fix the threshold value.

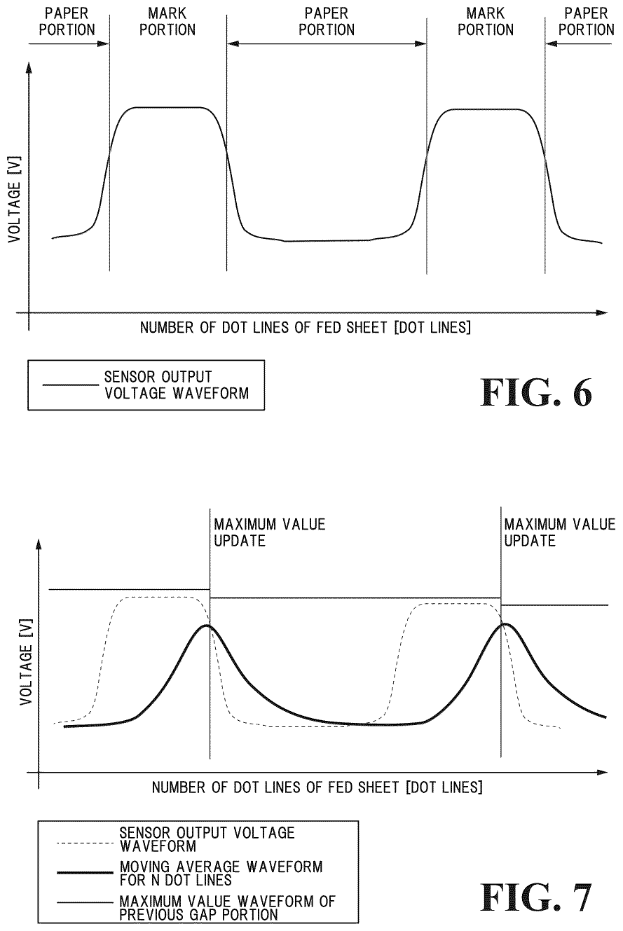

FIG. 6 is a graph for showing changes in the theoretical value of the voltage output from the second sensor during sheet conveyance in the at least one embodiment. The horizontal axis indicates the number of dot lines of the fed sheet [dot lines], and the vertical axis indicates the theoretical value [V] of the voltage output from the second sensor 152. As shown in FIG. 6, it can be seen that the voltage output from the second sensor 152 is low at the paper portions and high at the mark portions.

The voltage may change each time a mark portion is passed. In other words, it can be said that the voltage value varies for each mark portion or paper portion. This variation gradually changes each time the sheet passes over the second sensor 152. For example, there may be a difference between the position at which the sheet passes in the height direction when the sheet located on a relatively outer side of the roll sheet is conveyed and the position at which the sheet passes in the height direction when the sheet located on a relatively inner side of the roll sheet is conveyed. The voltage value changes gradually, and thus it is possible to suitably determine whether the portion of the sheet is a mark portion or a paper portion by determining the threshold value for determining whether the portion of the sheet is a mark portion or a paper portion based on the voltage value obtained when the sheet passed last time.

FIG. 7 is a graph for showing an output waveform of a sensor during sheet conveyance, a moving average waveform for N dots, and a maximum value waveform of a previous gap portion. In FIG. 7, the moving average waveform for N dots and the maximum value waveform of the previous gap portion relative to the waveform of the voltage value output from the second sensor 152 (sensor output voltage waveform) described with reference to FIG. 6 are additionally shown.

The moving average waveform for N dots is a waveform obtained by calculating a moving average from the sensor output voltage based on a predetermined number of samples, and plotting the calculated values. The maximum value waveform of the previous gap portion is a waveform indicating the maximum value at the mark portion. The maximum value waveform of the previous gap portion may be updated at the timing at which a mark portion is passed (that is, paper portion is detected). In the example of FIG. 7, it can be seen that the maximum value of the previous gap portion gradually decreases each time a mark portion is passed.

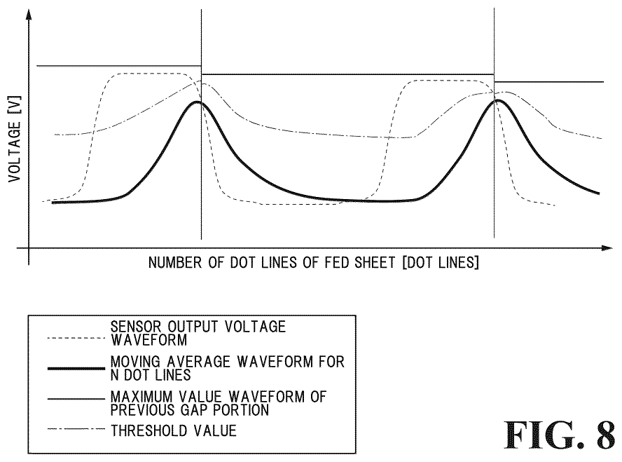

FIG. 8 is a graph for showing an output waveform of a sensor during sheet conveyance, a moving average waveform for N dots, a maximum value waveform of a previous gap portion, and a threshold value waveform. In FIG. 8, a threshold value relative to the three waveforms described with reference to FIG. 7 is additionally shown. The threshold value added in FIG. 8 is a threshold value for determining

whether the sheet is a mark portion or a paper portion. When the sensor output voltage is larger than the threshold value, it is determined that the sheet is a mark portion, and when the sensor output voltage is smaller than the threshold value, it is determined that the sheet is a paper portion. The threshold value is calculated based on the moving average waveform for N dots and the maximum value waveform of the previous gap portion, and is updated for each dot line of the fed sheet. More specifically, the threshold value may be the average value of the moving average waveform for N dots and the maximum value waveform of the previous gap portion. The threshold value is not limited to this example, and may be any threshold value which is based on the moving average waveform for N dots and the maximum value waveform of the previous gap portion.

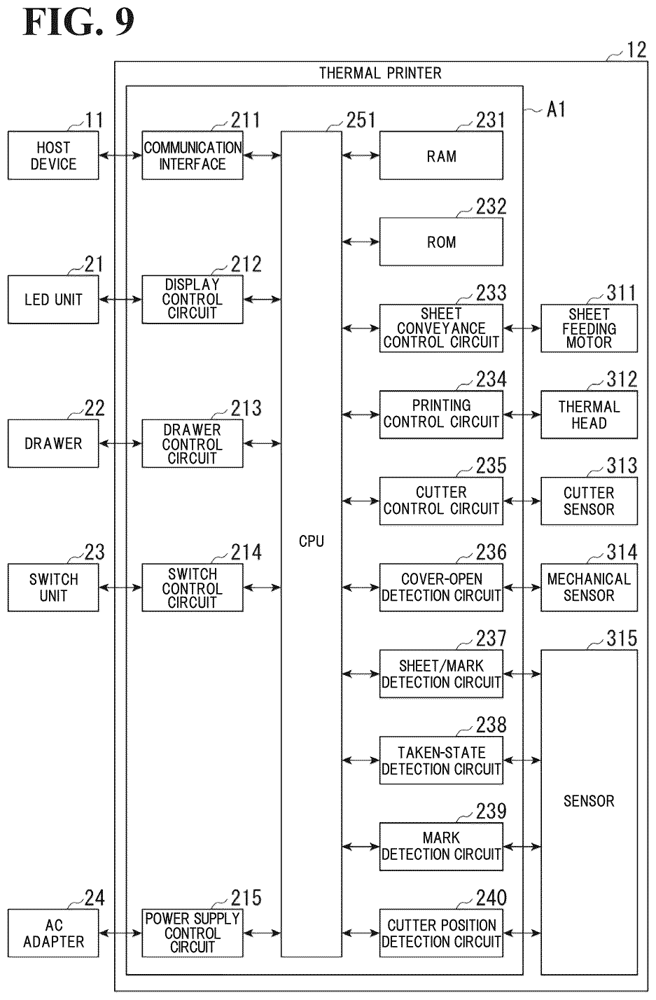

FIG. 9 is a function configuration diagram for illustrating an example of a function configuration of the thermal printer according to the at least one embodiment. An example of the function configuration of the thermal printer 12 is described with reference to FIG. 9. In the following description, a case in which the thermal printer 12 is applied to a point of sale (POS) terminal, but the at least one embodiment is not limited to this example. For example, the thermal printer 12 may operate in a stand-alone manner, or may operate based on instructions from another terminal device such as a smartphone.

The thermal printer 12 includes a functional unit Al which includes a CPU 251 and peripheral functions of the CPU 251, a sheet feeding motor 311, a thermal head 312, a cutter motor 313, a mechanical sensor 314, and a sensor 315. The sheet feeding motor 311 may be referred to as “conveyance motor.”

The functional unit Al includes a communication interface 211, a display control circuit 212, a drawer control circuit 213, a switch control circuit 214, a power supply control circuit 215, a RAM 231, a ROM 232, a sheet conveyance control circuit 233, a printing control circuit 234, a cutter control circuit 235, a cover-open detection circuit 236, a sheet/mark detection circuit 237, a taken-state detection circuit 238, a mark detection circuit 239, and a cutter position detection circuit 240.

In the at least one embodiment, the thermal printer 12 includes a processor (the CPU 251 in the at least one embodiment) and a memory such as the ROM 232 and the RAM 231. In the thermal printer 12, the processor executes a predetermined program by using the memory, to thereby execute various types of processing. The program may be stored in the memory. In the at least one embodiment, a case in which a function of a sheet determination unit which determines a kind of a sheet is implemented by functions of the CPU 251 is illustrated. However, as another example, the thermal printer 12 may include, separately from the CPU 251, the sheet determination unit which determines a kind of a sheet.

Further, in FIG. 9, as devices which are external to the thermal printer 12, there are provided the host device 11, a light-emitting-diode (LED) unit 21, a drawer 22, a switch unit 23, and an alternating-current (AC) adapter 24.

The LED unit 21 includes one or more LEDs, and displays predetermined information through light emission or blinking of the LEDs. The drawer 22 is a cash drawer of a POS register. The switch unit 23 includes one or more switches, and receives an instruction in accordance with an operation made by a user on the switch. The switch unit 23 may include a switch which receives an instruction of, for example, feeding. The AC adapter 24 is connected to, for example, a commercial power supply, and converts alternating-current power supply from the commercial power supply into direct-current power supply.

Next, description is given of the function of each functional unit of the thermal printer 12.

The sheet feeding motor 311 is a motor which conveys a sheet. The sheet feeding motor 311 may be a stepping motor which rotates by a predetermined angle when an electric signal (for example, a DC pulse voltage) is input.

The thermal head 312 is a head which performs printing on a sheet by heat. The thermal head 312 includes a plurality of heating elements (heaters) arranged in a row on a heat storage layer (glaze). The thermal printer 12 performs printing for one dot line by controlling the energization state of each of the plurality of heating elements included in the thermal head 312. The thermal printer 12 performs two-dimensional printing by alternately performing sheet feeding and printing for one dot line.

The cutter motor 313 is a motor which drives a cutter (not shown). The cutter motor 313 may be, for example, a direct-current (DC) motor which drives a rotary cutter or the like (not shown).

The mechanical sensor 314 has a mechanical contact, and detects whether the housing upper portion 111a is in an open state or a closed state.

The sensor 315 detects values (for example, physical quantities) for detection of information by each of the sheet/mark detection circuit 237, the taken-state detection circuit 238, the mark detection circuit 239, and the cutter position detection circuit 240. The sensor 315 includes different sensors for the sheet/mark detection circuit 237, the taken-state detection circuit 238, the mark detection circuit 239, and the cutter position detection circuit 240, respectively. A reflective PI sensor may be used as the sensor 315.

The sheet conveyance control circuit 233 controls the sheet feeding motor 311 in accordance with an instruction from the CPU 251. The printing control circuit 234 controls the thermal head 312 in accordance with an instruction from the CPU 251. The cutter control circuit 235 controls the cutter motor 313 in accordance with an instruction from the CPU 251.

The cover-open detection circuit 236 detects a cover-open state, in which the housing upper portion 111a is opened, based on a result of detection by the mechanical sensor 314, and notifies the detection result to the CPU 251. When the thermal printer 12 is not in a cover-open state, this means that the thermal printer 12 is in a cover-closed state, in which the housing upper portion 111a is closed.

The sheet/mark detection circuit 237 detects a sheet or a mark based on a result of detection by the sensor 315, and notifies the detection result to the CPU 251. The taken-state detection circuit 238 detects that a sheet (for example, a sheet that has been cut) has been taken based on a result of detection by the sensor 315, and notifies the detection result to the CPU 251. The mark detection circuit 239 detects a mark based on a result of detection by the sensor 315, and notifies the detection result to the CPU 251. The cutter position detection circuit 240 detects a cutter position (position at which a sheet is cut by a cutter) based on a result of detection by the sensor 315, and notifies the detection result to the CPU 251.

The communication interface 211 is an interface which performs communication to and from the host device 11. The CPU 251 performs communication to and from the host device 11 via the communication interface 211. In the at least one embodiment, for example, print data or the like is transmitted from the host device 11 to the thermal printer 12.

The display control circuit 212 controls the LED unit 21 in accordance with an instruction from the CPU 251 to cause the LED unit 21 to display desired information. The drawer control circuit 213 controls the state of the drawer 22 (for example, performs control of opening the drawer 22) in accordance with an instruction from the CPU 251. The switch control circuit 214 receives an instruction corresponding to an operation performed on the switch of the switch unit 23, and notifies the CPU 251 of the instruction. The power supply control circuit 215 supplies electric power input from the AC adapter 24 to the CPU 251. In the at least one embodiment, each functional unit of the thermal printer 12 operates by using the thus-supplied electric power.

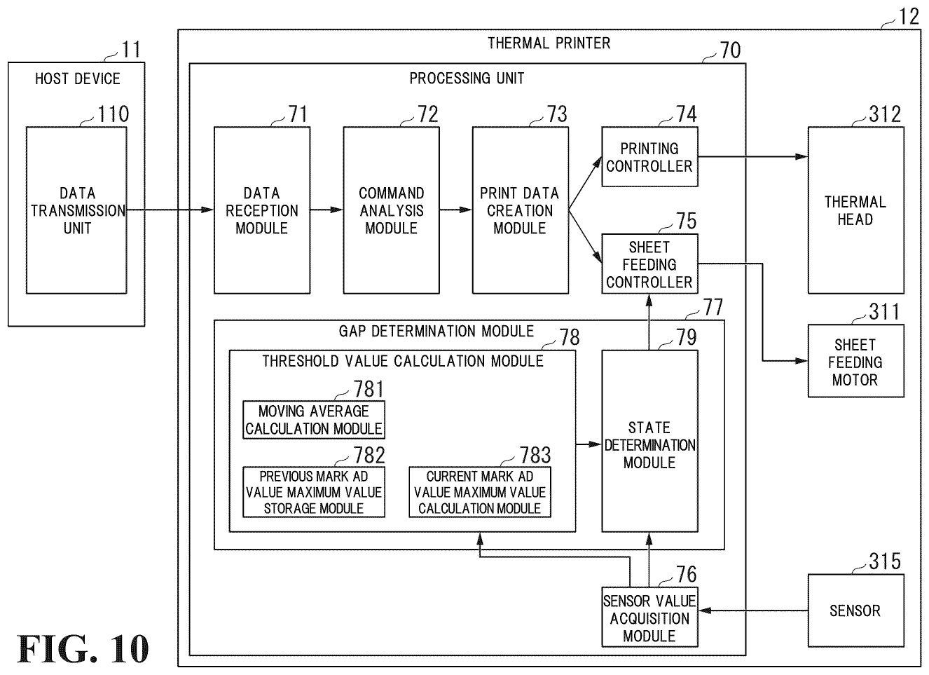

FIG. 10 is a function configuration diagram for illustrating an example of a detailed function configuration of a processing unit included in the thermal printer according to the at least one embodiment. An example of a detailed function configuration of a processing unit 70 included in the thermal printer 12 is described with reference to FIG. 10. The processing unit 70 is an example of a functional unit included in the CPU 251. The processing unit 70 may be referred to as “thermal printer control device.”

The processing unit 70 includes a data reception module 71, a command analysis module 72, a print data creation module 73, a printing controller 74, a sheet feeding controller 75, a sensor value acquisition module 76, and a gap determination module 77. Each of those functional units may be implemented by the CPU 251 executing a program stored in the RAM 231 or ROM 232.

The data reception module 71 receives information including, for example, print data and commands from the data transmission unit 110 included in the host device 11. The print data may be binary data including, for example, a character size and a print pattern. The data received by the data reception module 71 from the data transmission unit 110 may include information on the type of the sheet. The information on the type of the sheet may include information on a length of the mark in a conveyance direction. The data reception module 71 acquires information on the sheet, and thus can also be referred to as “sheet information acquisition module.”

The command analysis module 72 analyzes a command received by the data reception module 71. The command may be based on, for example, a standard such as ESC/POS (trademark).

The print data creation module 73 creates print data based on the information analyzed by the command analysis module 72. The created print data is passed to the printing controller 74 and the sheet feeding controller 75.

The printing controller 74 drives the thermal head 312 based on the print data created by the print data creation module 73. Specifically, the printing controller 74 transmits the print data, a latch signal, a strobe signal, and the like to the thermal head 312. The printing controller 74 can also be referred to as “thermal head driver.”

The sheet feeding controller 75 drives the sheet feeding motor 311 based on the print data created by the print data creation module 73. Specifically, the sheet feeding controller 75 conveys the sheet by transmitting a predetermined pulse signal to the sheet feeding motor 311.

The sensor value acquisition module 76 acquires a sensor value from the sensor 315. The sensor 315 includes a PI sensor. The PI sensor detects the intensity of reflected light obtained when light is irradiated on the sheet. The PI sensor outputs an analog voltage as the sensor value to the sensor value acquisition module 76. The sensor value acquisition module 76 converts the analog value acquired from the sensor 315 into a digital value, and outputs the digital value to the gap determination module 77. An A/D conversion circuit for A/D conversion may be included in the sensor value acquisition module 76, or an A/D conversion circuit (not shown) may be used.

The gap determination module 77 determines whether the portion of the sheet passing over the sensor is a mark portion or a paper portion based on the sensor value acquired from the sensor value acquisition module 76. Specifically, the gap determination module 77 implements this function by including a threshold value calculation module 78 and a state determination module 79. The state determination module 79 may be simply referred to as “determination module.”

The threshold value calculation module 78 calculates a threshold value based on the sensor value acquired by the sensor value acquisition module 76. The threshold value is for detecting whether the portion of the sheet passing over the sensor is a mark portion or a paper portion (that is, for detecting the presence or absence of a mark). The threshold value calculation module 78 calculates the threshold value based on a first sensor value which is the sensor value obtained when the mark is detected and a second sensor value which is the sensor value obtained when the mark is not detected. The first sensor value is the maximum value of the sensor values in a section in which the mark portion was detected last time. The second sensor value is a moving average calculated from N sensor values (N is a natural number of 1 or more) acquired from the same sensor (specifically, a PI sensor).

More specifically, the threshold value calculation module 78 calculates the threshold value by including a moving average calculation module 781, a previous mark AD value maximum value storage module 782, and a current mark AD value maximum value calculation module 783. The calculation of the threshold value is performed as described with reference to FIG. 8. The moving average calculation module 781 calculates a moving average for N dots. A magnitude of N may be determined based on the information on the length of the mark in the conveyance direction acquired by the sheet information acquisition module. The previous mark AD value maximum value storage module 782 stores the maximum value of the sensor value in the section in which the mark portion was detected last time. The current mark AD value maximum value calculation module 783 calculates the maximum value of the sensor value in the section in which the current mark portion is detected. The calculation processing may be processing that is sequentially updated in accordance with the acquired value. The maximum value of the sensor value in the section in which the current mark portion calculated by the current mark AD value maximum value calculation module 783 is detected may be overwritten and stored in the previous mark AD value maximum value storage module 782 when a transition from the mark portion to the paper portion is detected.

The threshold value calculation module 78 calculates the threshold value based on the moving average value calculated by the moving average calculation module 781 (in this paragraph, this may be simply referred to as “moving average value”) and the maximum value of the sensor value in the section in which the mark portion was detected stored in the previous mark AD value maximum value storage module 782 (in this paragraph, this may be referred to as “maximum sensor value”). For example, the threshold value calculation module 78 can set the threshold value to any value between the moving average value and the maximum value. Specifically, the threshold value may be set to a value from about 30% to about 70% of a range between the moving average value as the minimum value and the maximum sensor value as the maximum value. It is preferred to set the threshold value to a value about 50% (that is, the average value) of the range between the moving average value as the minimum value and the maximum sensor value as the maximum value.

The state determination module 79 determines whether the portion of the sheet passing over the sensor is a mark portion or a paper portion (that is, determines the presence or absence of a mark) based on the result of a comparison between the sensor value acquired by the sensor value acquisition module 76 and the threshold value calculated by the threshold value calculation module 78. The state determination module 79 outputs the determined result to the printing controller 74 and the sheet feeding controller 75. The printing controller 74 and the sheet feeding controller 75 control driving of the thermal head 312 and the sheet feeding motor 311 such that printing is performed on a printing area based on the position of the mark portion.

When the length of the mark in the conveyance direction is too short, the moving average value may begin to decrease before the maximum value of the sensor value reaches an upper limit. In such a case, the number of samples N may be reduced or the maximum value may be weighted. The weighting value may be determined based on an evaluation result of the PI sensor. Specifically, the weighting value is calculated based on the waveform obtained when the PI sensor and the sheet are farthest from each other and the waveform obtained when the PI sensor and the sheet are closest to each other. The weighting value may be determined, for example, based on the result of an evaluation performed at the time of shipment from the factory or before shipment from the factory.

Further, the threshold value may be updated each time a dot line sheet is conveyed, updated each time a plurality of dot line sheets have been conveyed, updated after each mark, or updated each time after a plurality of marks. For example, when the threshold value is updated after each mark, the threshold value calculation module 78 may update the threshold value each time a downstream end of the mark in the conveyance direction is detected based on the result determined by the state determination module 79.

When the length of the mark portion in the conveyance direction is known in advance, whether or not the sheet is a mark portion may be determined based on the length of the mark portion. In other words, when the length of the detected mark portion is extremely shorter than the expected length, a false detection may have occurred, and such detection may be determined to be noise. That is, the state determination module 79 may determine the presence or absence of the mark each time a pulse is applied to the sheet feeding motor 311, and when it is consecutively determined a predetermined number of times or more that the mark is not present based on the length of the mark in the conveyance direction, determine that the portion of the sheet is not the mark.

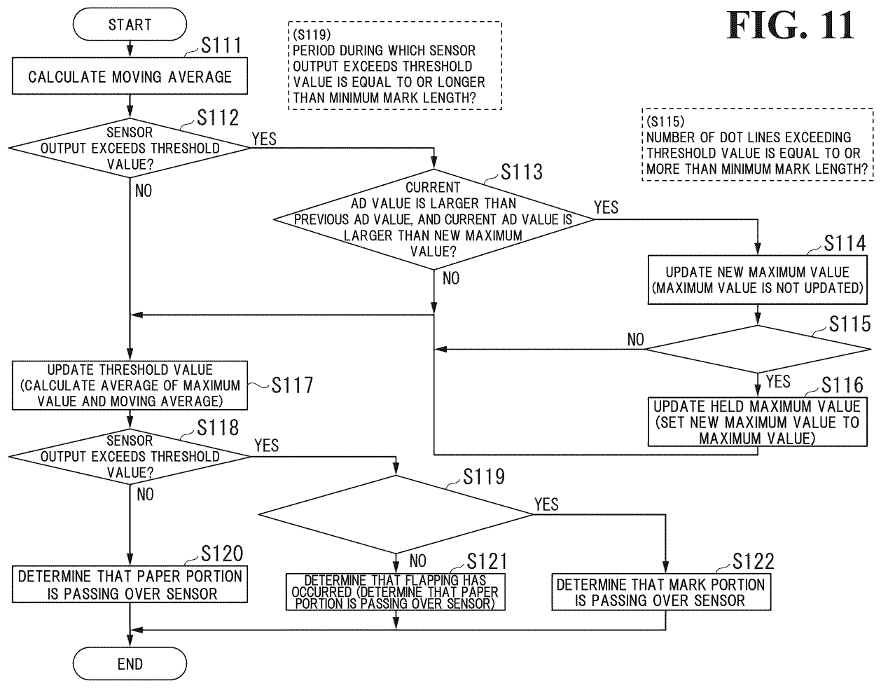

FIG. 11 is a flowchart for illustrating a series of operations performed by the thermal printer according to the at least one embodiment for determining whether the sheet is a mark portion or a paper portion. An example of a series of operations performed by the thermal printer 12 for determining whether the sheet is a mark portion or a paper portion is now described with reference to FIG. 11.
(Step S111) First, the moving average calculation module 781 calculates a moving average based on the sensor values of the previous N dots.
(Step S112) Next, the state determination module 79 determines whether or not the sensor output exceeds the currently set threshold value. At the time of the initial determination, a default value may be set. When the sensor output exceeds the currently set threshold value (that is, “YES” in Step S112), the state determination module 79 advances the process to Step S113. When the sensor output does not exceed the currently set threshold value (that is, “NO” in Step S112), the state determination module 79 advances the process to Step S117.
(Step S113) Next, the state determination module 79 compares the sensor value acquired by the sensor value acquisition module 76 (sometimes referred to as “AD value” because the sensor value is a value after A/D conversion) with the sensor value at the time of the previous dot line and the maximum value temporarily stored in the current mark AD value maximum value calculation module 783 (sometimes referred to as “new maximum value”). When the state determination module 79 determines that the sensor value acquired by the sensor value acquisition module 76 is larger than the sensor value at the time of the previous dot line and larger than the new maximum value (that is, “YES” in Step S113), the state determination module 79 advances the process to Step S114. When the state determination module 79 determines that the sensor value acquired by the sensor value acquisition module 76 does not satisfy the condition of being larger than the sensor value at the time of the previous dot line and larger than the new maximum value (that is, “NO” in Step S113), the state determination module 79 advances the process to Step S117.
(Step S114) In this case, the current mark AD value maximum value calculation module 783 updates the new maximum value. Further, the maximum value stored in the previous mark AD value maximum value storage module 782 (sometimes simply referred to as “maximum value”) is not updated.
(Step S115) When the state determination module 79 determines that the number of dot lines exceeding the threshold value is equal to or more than a minimum mark value set in advance (sometimes referred to as “minimum mark length”) (that is, “YES” in Step S115), the state determination module 79 advances the process to Step S116. When the state determination module 79 determines that the number of dot lines exceeding the threshold value is not equal to or more than the minimum mark length (that is, “NO” in Step S115), the state determination module 79 advances the process to Step S117.
(Step S116) The previous mark AD value maximum value storage module 782 updates the new maximum value held in the current mark AD value maximum value calculation module 783 as the new maximum value, and advances the process to Step S117.
(Step S117) The threshold value calculation module 78 updates the threshold value. The threshold value may be, for example, the average of the maximum value stored in the previous mark AD value maximum value storage module 782 and the moving average calculated by the moving average calculation module 781.
(Step S118) When the state determination module 79 determines that the sensor output acquired by the sensor value acquisition module 76 exceeds the threshold value calculated by the threshold value calculation module 78 (that is, “YES” in Step S118), the state determination module 79 advances the process to Step S119. Further, when the state determination module 79 determines that the sensor output acquired by the sensor value acquisition module 76 does not exceed the threshold value calculated by the threshold value calculation module 78 (that is, “NO” in Step S118), the state determination module 79 advances the process to Step S120.
(Step S119) The state determination module 79 determines whether or not the period during which the sensor output exceeds the threshold value (preferably the number of dot lines, but may also be time) is equal to or longer than the minimum mark length. When the state determination module 79 determines that the period during which the sensor output exceeds the threshold value is equal to or longer than the minimum mark length (that is, “YES” in Step S119), the state determination module 79 advances the process to Step S122. When the state determination module 79 determines that the period during which the sensor output exceeds the threshold value is not equal to or longer than the minimum mark length (that is, “NO” in Step S119), the state determination module 79 advances the process to Step S121.
(Step S120) In this case, the state determination module 79 determines that the paper portion is passing over the sensor.
(Step S121) In this case, the state determination module 79 determines that the information temporarily detected as a mark portion is a false detection, and determines that the paper portion is passing over the sensor.
(Step S122) In this case, the state determination module 79 determines that the mark portion is passing over the sensor.

### SUMMARY OF AT LEAST ONE EMBODIMENT

According to the at least one embodiment described above, the thermal printer control device controls the driving of the thermal printer 12. The thermal printer 12 includes the thermal head 312, and performs printing on a sheet having a mark arranged thereon. The thermal printer control device includes the sensor value acquisition module 76, which acquires a sensor value detected by a sensor that detects the intensity of reflected light obtained when light is irradiated on the sheet, the threshold value calculation module 78, which calculates a threshold value for detecting a presence or absence of the mark based on the sensor value acquired by the sensor value acquisition module 76, and the state determination module 79, which determines the presence or absence of the mark based on a result of comparing the sensor value acquired by the sensor value acquisition module 76 and the threshold value calculated by the threshold value calculation module 78. The threshold value calculation module calculates the threshold value based on a first sensor value, which is the sensor value obtained when the mark is detected, and a second sensor value, which is the sensor value obtained when the mark is not detected. As a result of adopting this configuration, the thermal printer control device according to the at least one embodiment can suitably detect the position of a label.

Further, in the at least one embodiment, the first senor value is the maximum value of the sensor values, and the second sensor value is a moving average calculated from N sensor values (N is a natural number of 1 or more) acquired from the same sensor. That is, in the at least one embodiment, the threshold value is determined based on the maximum value and the moving average value. In the at least one embodiment, the threshold value is based not only on the moving average value but also based on the maximum value at the time of previous mark portion detection, and thus the thermal printer control device according to the at least one embodiment can suitably detect the position of the label.

Further, in the at least one embodiment, the thermal printer control device further includes the sheet information acquisition module, which acquires information on the sheet including information on a length of the mark in a conveyance direction. In addition, a magnitude of N is determined based on the information acquired by the sheet information acquisition module. That is, in the at least one embodiment, the number of samples for calculating the moving average varies depending on the size of the mark (length in the conveyance direction). Therefore, in the at least one embodiment, even when the length of the mark changes, the mark portion and the paper portion can be suitably detected, and the position of the label can be detected.

Further, in the at least one embodiment, the threshold value calculation module 78 calculates the threshold value by setting the first sensor value to a value larger than the maximum value of the sensor values when the magnitude of N is equal to or less than a predetermined magnitude. Specifically, when the mark is too short, the threshold value calculation module 78 weights the maximum value so that the maximum value is larger than the actual value and the threshold value is more suitable. As a result, the thermal printer control device according to the at least one embodiment can suitably detect the position of the label.

Further, in the at least one embodiment, the threshold value calculation module 78 updates the threshold value each time a downstream end of the mark in the conveyance direction is detected (that is, after each mark) based on the result determined by the state determination module 79. In the at least one embodiment, the threshold value changes based on the immediately previous mark, and thus it is possible to handle even cases in which the characteristics of the sheet gradually change (for example, a curl becomes tighter).

Further, in the at least one embodiment, the state determination module 79 determines the presence or absence of the mark each time a pulse is applied to a stepping motor which conveys the sheet, and determines that the portion of the sheet is not the mark when the determination module consecutively determines a predetermined number of times or more that the mark is not present based on the length of the mark in the conveyance direction. That is, in the at least one embodiment, the state determination module 79 suitably detects noise, and does not determine that the mark portion is present in cases of noise. Therefore, the thermal printer control device according to at least one embodiment can accurately detect the position of the label.

In the above, the at least one embodiment of the present invention has been described in detail with reference to the accompanying drawings. However, specific configurations of the present invention are not limited to those of the at least one embodiment and encompass design modifications and the like without departing from the gist of the present invention.

Further, a computer program for implementing the functions of each of the above-mentioned devices may be recorded on a computer-readable recording medium, and the program recorded on the recording medium may be read into a computer system and executed. The term “computer system” may encompass OSs as well as peripheral equipment and other types of hardware. The “computer-readable recording medium” refers to a flexible disk, a magneto-optical disc, a ROM, a writable non-volatile memory such as a flash memory, a portable medium such as a digital versatile disc (DVD), or a storage device such as a hard disk drive built in a computer system.

The term “computer-readable recording medium” also encompasses what holds a program for a given period of time, such as a volatile memory (such as a dynamic random access memory (DRAM)) inside a computer system that serves as a server or a client when a program is transmitted over the Internet or a similar network or via a telephone line or a similar communication line. The program described above may be transmitted from a computer system in which the program is stored in a storage device or the like to another computer system via a transmission medium or on transmission waves in a transmission medium. The “transmission medium” through which the program is transmitted refers to a medium having a function of transmitting information, such as the Internet or a similar network (a communication network), or a telephone line or a similar communication line (a communication wire). The program described above may also be a program for implementing some of the functions described above. The program described above may also be what is called a differential file (a differential program), with which the functions described above can be implemented by being used in combination with a program already recorded in the computer system.

What is claimed is:

1. A thermal printer control device for controlling a thermal printer which includes a thermal head and which is configured to perform printing on a sheet having a mark arranged thereon, the thermal printer control device comprising:
a sensor value acquisition module configured to acquire a sensor value detected by a sensor configured to detect an intensity of reflected light obtained when light is irradiated on the sheet;
a threshold value calculation module configured to calculate a threshold value for detecting a presence or absence of the mark based on the sensor value acquired by the sensor value acquisition module; and
a determination module configured to determine the presence or absence of the mark based on a result of comparing the sensor value acquired by the sensor value acquisition module and the threshold value calculated by the threshold value calculation module,
the threshold value calculation module being configured to calculate the threshold value based on a first sensor value which is the sensor value obtained when the mark is detected and a second sensor value which is the sensor value obtained when the mark is not detected.

2. The thermal printer control device according to claim 1, wherein the second sensor value is a moving average calculated from N sensor values acquired from the same sensor, where N is a natural number of 1 or more.

3. The thermal printer control device according to claim 2, further comprising a sheet information acquisition module configured to acquire information on the sheet including information on a length of the mark in a conveyance direction,
wherein a magnitude of N is determined based on the information on the length of the mark in the conveyance direction acquired by the sheet information acquisition module.

4. The thermal printer control device according to claim 2, wherein the first sensor value is a maximum value of the sensor values.

5. The thermal printer control device according to claim 4, wherein the threshold value calculation module is configured to calculate the threshold value by setting the first sensor value to a value larger than the maximum value of the sensor values when a magnitude of N is equal to or less than a predetermined magnitude.

6. The thermal printer control device according to claim 1, wherein the threshold value calculation module is configured to update the threshold value each time a downstream end of the mark in a conveyance direction is detected based on a result determined by the determination module.

7. The thermal printer control device according to claim 1, wherein the determination module is configured to determine the presence or absence of the mark each time a pulse is applied to a stepping motor configured to convey the sheet, and to determine that a portion of the sheet is not the mark when the determination module consecutively determines a predetermined number of times or more that the mark is not present based on a length of the mark in a conveyance direction.

8. A thermal printer, comprising:
a conveyance motor configured to convey a sheet;
a thermal head configured to perform printing by subjecting the sheet to heat;
a sensor configured to detect an intensity of reflected light obtained when light is irradiated on the sheet; and
the thermal printer control device of claim 1, which is configured to detect the presence or absence of the mark based on the sensor value detected by the sensor, and to control printing based on a position of the mark.

9. A thermal printer control method of controlling a thermal printer which includes a thermal head and which is configured to perform printing on a sheet having a mark arranged thereon, the thermal printer control method comprising:
acquiring a sensor value detected by a sensor configured to detect an intensity of reflected light obtained when light is irradiated on the sheet;
calculating a threshold value for detecting a presence or absence of the mark based on the sensor value acquired in the acquiring of the sensor value; and
determining the presence or absence of the mark based on a result of comparing the sensor value acquired in the acquiring of the sensor value and the threshold value calculated in the calculating of the threshold value,
the calculating of the threshold value including calculating the threshold value based on a first sensor value which is the sensor value obtained when the mark is detected and a second sensor value which is the sensor value obtained when the mark is not detected.

10. A non-transitory computer readable storage medium comprising instructions executed by a computer to control a thermal printer which includes a thermal head and which is configured to perform printing on a sheet having a mark arranged thereon, the instructions executed by the computer to implement:
acquiring a sensor value detected by a sensor configured to detect an intensity of reflected light obtained when light is irradiated on the sheet;
calculating a threshold value for detecting a presence or absence of the mark based on the sensor value acquired in the acquiring of the sensor value; and
determining the presence or absence of the mark based on a result of comparing the sensor value acquired in the acquiring of the sensor value and the threshold value calculated in the calculating of the threshold value,
the calculating of the threshold value including calculating the threshold value based on a first sensor value which is the sensor value obtained when the mark is detected and a second sensor value which is the sensor value obtained when the mark is not detected.
